(19) United States
(12) Patent Application Publication
(10) Pub. No.: US 2012/0156084 A1
(43) Pub. Date: Jun. 21, 2012

(54) METHOD OF MANUFACTURING SINTERED FERROMOLYBDENUM ALLOY FROM MIXED POWDER OF MILL SCALE AND MOLYBDENUM OXIDE POWDER BY SOLID GAS REACTION

(75) Inventors: Byung-Su Kim, Gunsan-si (KR); Sang-Bae Kim, Daejeon (KR); Taegong Ryu, Daegon (KR); Young-Yoon Choi, Daegon (KR); Hooin Lee, Daegon (KR)

(73) Assignee: KOREA INSTITUTE OF GEOSCIENCE AND MINERAL RESOURCE (KIGAM), Daejeon (KR)

(21) Appl. No.: 13/386,146

(22) PCT Filed: Aug. 22, 2011
(86) PCT No.: PCT/KR11/06185

§ 371 Date: Feb. 16, 2012

(30) Foreign Application Priority Data
Aug. 24, 2010 (KR) 10-2010-0081912

(51) Int. Cl. B22F 1/00; B32B 15/02; B22F 3/12

(52) U.S. Cl. 419/33; 75/228

(57) ABSTRACT

The present invention relates to a method for manufacturing a sintered ferromolybdenum alloy, in which a mixed powder of a mill scale (a mixture of Fe, FeO and Fe₂O₃) as a ferrous raw material discharged from a hot rolling and forging process of the steel-making process and a molybdenum oxide powder as a molybdenum raw material is primarily reduced with a hydrogen gas at low temperature, and then is secondarily reduced with the hydrogen gas at high temperature and simultaneously is cooled in a hydrogen atmosphere to thereby obtain a ferromolybdenum alloy in the form of a powder, and subsequently the obtained ferromolybdenum alloy powder is mixed with wax (Kenolube P11) and the wax-containing mixture is compacted or pressure-molded, after which the molded product is heat-treated in a hydrogen gas atmosphere and then is cooled, thereby manufacturing a sintered ferromolybdenum alloy, and a sintered product manufactured by said method.

### TECHNICAL FIELD The pre

t invention relates to a method for manufacturing a sintered ferromolybdenum alloy used for adjustment of components of a molten metal in a steel-making process for manufacturing special steels, and a sintered ferromolybdenum alloy manufactured by the same method, and more particularly, to such a method for manufacturing a sintered ferromolybdenum alloy, in which a mixed powder of a mill scale (a mixture of Fe, FeO and Fe₂O₃) as a ferrous raw material discharged from a hot rolling and forging process of the steel-making process and a molybdenum oxide powder as a molybdenum raw material is primarily reduced with a hydrogen gas at low temperature, and then is secondarily reduced with the hydrogen gas at high temperature and simultaneously is cooled in a hydrogen atmosphere to thereby obtain a ferromolybdenum alloy in the form of a powder, and subsequently the obtained ferromolybdenum alloy powder is mixed with wax (Kenolube P11) and the wax-containing mixture is compacted or pressure-molded, after which the molded product is heat-treated in a hydrogen gas atmosphere and then is cooled, thereby manufacturing a sintered ferromolybdenum alloy, and a sintered product manufactured by said method.

### BACKGROUND ART

A small amount of special metal is added to steel in a molten state to improve the properties of steel in a steel-making process for producing special steels. Molybdenum is contained in the added special metal. Typically, a molybdenum oxide briquette is often added to steel in a molten state, but a ferromolybdenum alloy may be added thereto. Since molybdenum acts to improve creep resistance of steel and prevent temper embrittlement of steel, it is mostly used in large quantities as a substitute for a heat resisting steel. In addition, molybdenum may be added in small quantities to cast iron in a molten state in order to improve the heat resistant property of the cast iron in a cast iron manufacturing process. The ferromolybdenum alloy and a ferroalloy used for adjustment of components of a molten metal in a manufacturing process of special steels having a high melting point such as ferrovanadium, ferrotitanium, and ferrochrome are generally manufactured by a thermite reaction.

The thermite reaction employs aluminum, magnesium, or ferrosilicon alloy having a high oxidation power as both a reducing agent and a heat source to cause a reduction reaction to occur in which oxygen is removed from a metal oxide having a high melting point. In the reduction reaction, the metal oxide having a high melting point is dissolved and reduced by a strong oxidation reaction heat of aluminum, magnesium, or silicon to manufacture a ferroalloy. In a thermite reaction for manufacturing a ferromolybdenum alloy, when aluminum, magnesium, or ferrosilicon are typically mixed with scrap iron, molybdenum oxide, lime, and silica and the mixture is ignited, a high-temperature oxidation reaction (thermite reaction) occurs to obtain the ferromolybdenum alloy by a high-temperature oxidation reaction heat. Thus, in case of manufacturing the ferromolybdenum alloy using the thermite method, since the use of a slag-forming agent and a fire-igniting agent as well as aluminum, magnesium, or ferrosilicon for the thermite reaction besides the ferrous raw material and the molybdenum raw material is essentially required, there is an urgent need for the saving of a subsidiary raw material used and for the development of a substitute for the subsidiary raw material.

Furthermore, since the thermite reaction creates short bursts of extremely high temperatures for a short period of time (e.g., for several minutes or so), an environmental pollution preventing facility is also required which treats a large quantity of environment polluting gas and dust generated during the thermite reaction. In addition, the thermite reaction entails a problem in that an extreme amount of secondary solid wastes of slag and waste foundry sand is produced during the reaction. First of all, the thermite reaction encounters a drawback in that dust partially containing molybdenum is produced during the thermite reaction and slag partially containing molybdenum is formed after the thermite reaction, thereby deteriorating the recovery rate of molybdenum. Moreover, a large amount of dust containing molybdenum is again produced even in the process of pulverizing a ferromolybdenum alloy according to the use purpose after the thermite reaction, thereby deteriorating the recovery rate of molybdenum.

Meanwhile, a ferromolybdenum alloy nugget manufactured by the thermite method has a difference in composition (or content) by each portion thereof, and hence there is a reproducibility problem for the homogeneous composition of the ferromolybdenum alloy. The composition inhomogeneity of the ferromolybdenum alloy nugget makes it difficult to adjust the process time due to a change in the dissolution rate of the ferromolybdenum alloy into a melt, which is caused by a density difference of the ferromolybdenum alloy nugget at the time of introducing the ferromolybdenum alloy into a molten steel, as well as to adjust the concentration of the molybdenum metal to the molten steel. Besides, there occur a problem of inclusion of impurities, for example, such as inclusion of foundry sand in the ferromolybdenum alloy during the melting and inclusion of a reducing agent such as alumina, magnesium, or silicon at the time of manufacturing the ferromolybdenum alloy using a high-temperature heat of oxidation reaction.

In the meantime, recently, a process is proposed in which iron oxide and molybdenum oxide are primarily molten and the mixture is reduced with hydrogen, and then the resulting mixture is reduced secondarily. However, such a process has a shortcoming in that molybdenum oxide (MoO₃) shows a significantly large volatilization loss, and the hydrogen reduction time is extended in the primarily melting and hydrogen reducing step.

In addition, a process is proposed in which a mixture of an iron powder and a molybdenum oxide powder in the form of a sintered material (for example, briquette) is reduced with hydrogen gas to manufacture a ferromolybdenum alloy. However, such a process still has shortcomings in that the hydrogen reduction step is carried out at a high temperature of more than 1,000° C., resulting in occurrence of volatilization loss of the molybdenum oxide (MoO₃), and in that the hydrogen reduction time is lengthened, resulting in an increase in the entire process time, and molybdenum oxide (MoO₃ or MoO₂) is insufficiently reduced.

Accordingly, the present inventors have made extensive efforts to solve the problems associated with the conventional prior arts and, as a result, have found that a mixed powder of a mill scale (a mixture of Fe, FeO and Fe₂O₃) discharged from a hot rolling and forging process of the steel-making process and a molybdenum oxide powder is primarily reduced with a hydrogen gas at low temperature, and then is secondarily reduced with the hydrogen gas at high temperature and simultaneously is cooled in a hydrogen atmosphere to thereby obtain a ferromolybdenum alloy in the form of a powder, and subsequently the obtained ferromolybdenum alloy powder is mixed with wax (Kenolube P11) and the wax-containing mixture is compacted or pressure-molded, after which the molded product is heat-treated in a hydrogen gas atmosphere and then is cooled to thereby manufacture a sintered ferromolybdenum alloy, thereby completing the present invention.

### DISCLOSURE OF INVENTION

### Technical Problem

An object of the present invention is to provide a method for manufacturing a sintered ferromolybdenum alloy, which can prevent introduction of additional materials besides a ferrous raw material and a molybdenum raw material in the manufacture of a ferromolybdenum alloy using the thermite reaction, can reduce the investment cost of an environmental pollution preventing facility, and can allow the sintered ferromolybdenum alloy to have a homogeneous composition.

Another object of the present invention is to provide a method for manufacturing a sintered ferromolybdenum alloy, in which a ferromolybdenum alloy is formed in a powder state from a mill scale and a molybdenum oxide powder at a reduction reaction rate which is higher than that in the case where a mixture of an iron powder and a molybdenum oxide powder is reduced with hydrogen gas in a briquette state to form a ferromolybdenum alloy, such that the volatilization loss of the molybdenum oxide can be decreased by lowering the process temperature in the manufacture of the ferromolybdenum alloy by the hydrogen reduction, the process time can be shortened to increase the productivity, and the use amount of expensive hydrogen can be reduced.

Still another object of the present invention is to provide a method for manufacturing a sintered ferromolybdenum alloy, in which a ferromolybdenum alloy powder is obtained by a two-stage hydrogen reduction, such that the volatilization loss of molybdenum oxide occurring in its melted state during the hydrogen reduction can be prevented, a mill scale which is an industrial by-product material is used as a substitute for scrap iron or iron powder which are more expensive than the mill scale used as a ferrous raw material,thereby reducing the manufacturing cost.

### Technical Solution

In order to achieve the above object, the present invention provides a method for manufacturing a sintered ferromolybdenum alloy from a mixed powder of a mill scale (a mixture of Fe, FeO and Fe₂O₃) and a molybdenum oxide (MoO₃) powder by a solid-gas reaction, the method including the steps of:

(a) grinding a mill scale, which is used as a ferrous raw material, to a particle size of 75-150 μm using a ball mill, while uniformly mixing the mill scale with the molybdenum oxide powder;

(b) primarily partially reducing the mixture resulting from the step (a), where the reducing carried out with hydrogen at low temperature;

(c) secondarily reducing the mixture resulting from the step (b), where the reducing carried out with hydrogen at high temperature, but without cooling the mixture, to form a ferromolybdenum alloy powder;

(d) cooling the mixed alloy resulting from the step (c) in a hydrogen atmosphere to obtain a ferromolybdenum alloy powder;

(e) mixing the ferromolybdenum alloy powder resulting from the step (d) with wax (Kenolube P11) and compacting or pressure-molding the wax-containing mixture;

(f) heating the molded product resulting from the step (e) to 700° C. in a nitrogen atmosphere, and then hot-sintering the molded product at a temperature of 700-900° C. for 30-100 minutes in a hydrogen atmosphere; and

(g) cooling the sintered product resulting from the step (f) to 550° C. in a hydrogen atmosphere, and then cooling the sintered product to 150-250° C. in a nitrogen atmosphere.

### BRIEF DESCRIPTION OF THE DRAWINGS

The above and other objects, features, and advantages of the present invention will be apparent from the following detailed description of the preferred embodiments of the invention in conjunction with the accompanying drawings, in which:

FIG. 1 is a flow chart illustrating a process for manufacturing a sintered ferromolybdenum alloy from a mixed powder of a mill scale (iron oxide) and a molybdenum oxide powder by a solid-gas reaction;

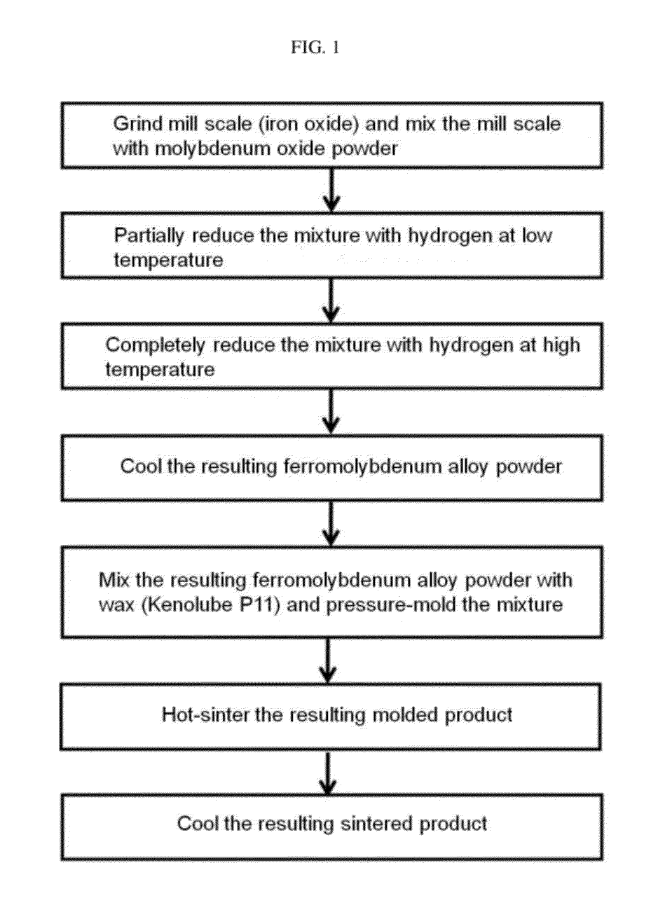

FIG. 2 illustrate a photograph taken by an electron microscope of tissues of ground powders of a sintered ferromolybdenum alloy manufactured by a sintered ferromolybdenum alloy manufacturing method according to one embodiment of the present invention;

FIG. 3 is a diagram illustrating X-ray diffraction patterns of ground powders of a sintered ferromolybdenum alloy manufactured by a sintered ferromolybdenum alloy manufacturing method according to one embodiment of the present invention; and

FIG. 4 is a diagram illustrating X-ray diffraction patterns of ground powders of a ferromolybdenum alloy manufactured by a conventional thermite reaction.

### BEST MODE FOR CARRYING OUT THE INVENTION

Now, a preferred embodiment of the present invention will be described hereinafter in more detail with reference to the accompanying drawings.

Unless defined otherwise, all technical and scientific terms used herein have the same meaning as commonly understood by one of ordinary skill in the art to which the invention pertains. Generally, the nomenclature used herein and the experiment methods which will be described later are those well known and commonly employed in the art.

In one aspect, the present invention is directed to a method of manufacturing a sintered ferromolybdenum alloy from a mixed powder of a mill scale (a mixture of Fe, FeO and Fe₂O₃) and a molybdenum oxide (MoO₃) powder by a solid-gas reaction, the method including the steps of: (a) grinding a mill scale, which is used as a ferrous raw material, to a particle size of 75-150 μm using a ball mill, while uniformly mixing the mill scale with the molybdenum oxide powder; (b) partially reducing the mixture resulting from step (a) with hydrogen at low temperature; (c) completely reducing the mixture resulting from step (b) with hydrogen at high temperature to form a ferromolybdenum alloy powder; (d) cooling the mixed alloy resulting from step (c) in a hydrogen atmosphere to obtain a ferromolybdenum alloy powder; (e) mixing the ferromolybdenum alloy powder resulting from step (d) with wax (Kenolube P11) and compacting or pressure-molding the wax-containing mixture; (f) heating the molded product resulting from step (e) to 700° C. in a nitrogen atmosphere, and then hot-sintering the molded product at a temperature of 700-900° C. for 30-100 minutes in a hydrogen atmosphere; and (g) cooling the sintered product resulting from the step (f) to 550° C. in a hydrogen atmosphere, and then cooling the sintered product to 150-250° C. in a nitrogen atmosphere.

In the present invention, the mill scale used as an industrial by-product material is preferably a mixture of Fe, FeO and Fe₂O₃, and the molybdenum oxide is MoO₃.

Preferably, a powder of the mill scale has a particle size of 75-150 μm, and the molybdenum oxide powder has a particle size of 75-150 μm.

In the present invention, in the step (a) of grinding the mill scale, the particle size of the mill scale preferably ranges from 75 μm to 150 μm. If the particle size of the mill scale exceeds 150 μm, a problem will occur in that the ferromolybdenum alloy powder is not formed completely. On the contrary, if the particle size of the mill scale is less than 75 μm, there will be no advantage by a decrease of the particle size.

In the present invention, in the step (a), the uniform mixture of the mill scale with the molybdenum oxide powder is carried out for 30 minutes in a roller.

If the mixture time is less than 30 minutes, a problem will occur in that the mixture of the mill scale with the molybdenum oxide powder becomes non-uniform, and thus the ferromolybdenum alloy powder is not formed completely in the step (c). In order to solve such a problem, if the molybdenum oxide powder and the mill scale are simultaneously introduced into a ball mill used to grind the mill scale, they will mixed uniformly together while being ground, such that an economic profit can be created owing to elimination of a separate mixing process. On the contrary, if the mixture time exceeds 30 minutes, there will be no advantage by an increase in time.

In the present invention, the step (b) of partially reducing the mixture resulting from step (a) with hydrogen at low temperature is carried out at 550-600° C. for 30-100 minutes. If the solid-gas reaction temperature is less than 550° C., a problem will occur in that the reaction rate of the molybdenum oxide to the partial reduction is very slow, resulting in an increase in the reaction time. On the contrary, if solid-gas reaction temperature exceeds 600° C., a problem will occur in that the reaction rate of the molybdenum oxide to the partial reduction is fast, but a loss of molybdenum occurs due to evaporation of the molybdenum oxide (MoO₃).

In the present invention, the step (c) of completely reducing the mixture resulting from step (b) with hydrogen at high temperature is carried out at 750-950° C. for 30-100 minutes. If the solid-gas reaction temperature is less than 750° C., a problem will occur in that the reaction rate of the molybdenum oxide to the complete reduction is very slow, resulting in an increase in the reaction time. On the contrary, if solid-gas reaction temperature exceeds 950° C., a problem will occur in that the reaction rate of the molybdenum oxide to the complete reduction is not greatly increased, but much heat must be supplied.

In the present invention, the step (d) of cooling the mixed alloy resulting from the step (c) is carried out by cooling the mixed alloy to 300-500° C. in a hydrogen atmosphere. If the cooling temperature is less than 300° C., a problem will occur in that the cooling time is increased, resulting in an increase in a loss of hydrogen gas. On the contrary, if the cooling temperature exceeds 500° C., a problem will occur in that a trace amount of the reduced molybdenum and iron is re-oxidized.

In the present invention, the pressure-molding in the step (e) is carried out by mixing the ferromolybdenum alloy powder resulting from the step (d) uniformly with 2 wt %, based on the weight of the ferromolybdenum alloy powder, of the wax (Kenolube P11), and pressure-molding the wax-containing mixture at a pressure of 250 bar at room temperature, thereby obtaining a cylindrical molded product having a size of 2 cm (diameter)×2 cm (height). If the content of the wax (Kenolube P11) is less than 2 wt %, a problem will occur in that the strength of the molded product is decreased, resulting in breakage of the molded product. On the contrary, if the content of the wax (Kenolube P11) exceeds 2 wt %, a problem will occur in that the strength of the molded product is increased, but much wax (Kenolube P11) must be supplied. In addition, if the molding pressure is less than 250 bar, a problem will occur in that the strength of the molded product is decreased, resulting in breakage of the molded product. On the contrary, if the molding pressure exceeds 250 bar, a problem will occur in that the strength of the molded product is increased, but much energy must be supplied.

In the present invention, the hot sintering in the step (f) is carried out by heating the molded product resulting from the step (e) to 700° C. in a nitrogen atmosphere, and then heating the molded product to 750-900° C. in a hydrogen atmosphere, followed by hot sintering for 30-100 minutes. If the heating temperature of molded product is less than 750° C., a problem will occur in that the strength of the sintered product is decreased, resulting in breakage of the sintered product. On the contrary, if the heating temperature of molded product exceeds 900° C., a problem will occur in that the strength of the sintered product is increased, but much energy must be supplied.

In the present invention, the cooling in the step (g) is carried out by cooling the sintered ferromolybdenum alloy resulting from the step (f) to 150-250° C. in a hydrogen atmosphere. If the cooling temperature is less than 150° C., a problem will occur in that a loss of hydrogen gas is increased. Contrarily, if the cooling temperature exceeds 250° C., a problem will occur in that a trace amount of the reduced molybdenum and iron is re-oxidized.

Consequently, the present invention is intended to provide an energy-efficient and environmentally-friendly technique for manufacturing a sintered ferromolybdenum alloy, in which a mixed powder of the mill scale (a mixture of Fe, FeO and Fe₂O₃) as an industrial by-product material and the molybdenum oxide (MoO₃) powder is reduced with a hydrogen gas so that the reduction rate is fast and thus the working time is shortened, in which the necessity of a solid reducing agent such as aluminum, magnesium or ferrosilicon to be introduced separately will be removed, and in which dust and slag as second environment polluting substances are not produced, thereby reducing the investment cost of an environmental pollution preventing facility and maintaining uniformity of quality of the ferromolybdenum alloy.

### EXAMPLES

### Example 1

A mill scale (a mixture of Fe, FeO and Fe₂O₃) having a particle size of 75-150 μm and a molybdenum oxide (MoO₃) powder were used. The mill scale to the molybdenum oxide powder were weighed and uniformly mixed together so that the mixing ratio of the mill scale to the molybdenum oxide powder is 1:1.3.

The mixed powder of the mill scale and the molybdenum oxide powder was charged into an alumina crucible, and was placed in a temperature uniformity region within an electric furnace enabling the adjustment of a nitrogen gas atmosphere and hydrogen gas atmosphere. Then, the electric furnace was heated to 580° C. in a nitrogen gas atmosphere and the mixture was partially reduced for 60 minutes in a hydrogen gas atmosphere. Subsequently, the electric furnace was heated to 900° C. in a hydrogen gas atmosphere and the mixture was completely reduced for 50 minutes in a hydrogen gas atmosphere. Thereafter, the resulting mixed alloy was cooled to 500° C. in a hydrogen atmosphere to obtain a ferromolybdenum alloy powder.

Then, added to the cooled ferromolybdenum alloy powder was 2 wt %, based on the weight of the ferromolybdenum alloy powder, of the wax (Kenolube P11) and they were uniformly mixed together, and then the wax-containing mixture was compacted or pressure-molded at a pressure of 250 bar at room temperature, thereby obtaining a cylindrical molded product having a size of 2 cm (diameter)×2 cm (height). Thereafter, the obtained molded product was heated to 700° C. in a nitrogen atmosphere, and then was hot-sintered at a temperature of 750° C. for 100 minutes in a hydrogen atmosphere. Then, the sintered product was cooled to 550° C. in a hydrogen atmosphere, and then was cooled to 150° C. in a nitrogen atmosphere, thereby manufacturing a sintered ferromolybdenum alloy.

### Example 2

A mill scale (a mixture of Fe, FeO and Fe₂O₃) having a particle size of 75-150 μm and a molybdenum oxide (MoO₃) powder were used. The mill scale to the molybdenum oxide powder were weighed and uniformly mixed together so that the mixing ratio of the mill scale to the molybdenum oxide powder is 1:1.7.

The mixed powder of the mill scale and the molybdenum oxide powder was charged into an alumina crucible, and was placed in a temperature uniformity region within an electric furnace enabling the adjustment of a nitrogen gas atmosphere and hydrogen gas atmosphere. Then, the electric furnace was heated to 550° C. in a nitrogen gas atmosphere and the mixture was partially reduced for 30 minutes in a hydrogen gas atmosphere. Subsequently, the electric furnace was heated to 950° C. in a hydrogen gas atmosphere and the mixture was completely reduced for 40 minutes in a hydrogen gas atmosphere. Thereafter, the resulting mixed alloy was cooled to 400° C. in a hydrogen atmosphere to obtain a ferromolybdenum alloy powder.

Then, added to the cooled ferromolybdenum alloy powder was 2 wt %, based on the weight of the ferromolybdenum alloy powder, of the wax (Kenolube P11) and they were uniformly mixed together, and then the wax-containing mixture was compacted or pressure-molded at a pressure of 250 bar at room temperature, thereby obtaining a cylindrical molded product having a size of 2 cm (diameter)×2 cm (height). Thereafter, the obtained molded product was heated to 700° C. in a nitrogen atmosphere, and then was hot-sintered at a temperature of 800° C. for 60 minutes in a hydrogen atmosphere. Then, the sintered product was cooled to 550° C. in a hydrogen atmosphere, and then was cooled to 200° C. in a nitrogen atmosphere, thereby manufacturing a sintered ferromolybdenum alloy.

### Example 3

A mill scale (a mixture of Fe, FeO and Fe₂O₃) having a particle size of 75-150 μm and a molybdenum oxide (MoO₃) powder were used. The mill scale to the molybdenum oxide powder were weighed and uniformly mixed together so that the mixing ratio of the mill scale to the molybdenum oxide powder is 1:2.5.

The mixed powder of the mill scale and the molybdenum oxide powder was charged into an alumina crucible, and was placed in a temperature uniformity region within an electric furnace enabling the adjustment of a nitrogen gas atmosphere and hydrogen gas atmosphere. Then, the electric furnace was heated to 570° C. in a nitrogen gas atmosphere and the mixture was partially reduced for 70 minutes in a hydrogen gas atmosphere. Subsequently, the electric furnace was heated to 900° C. in a hydrogen gas atmosphere and the mixture was completely reduced for 30 minutes in a hydrogen gas atmosphere. Thereafter, the resulting mixed alloy was cooled to 450° C. in a hydrogen atmosphere to obtain a ferromolybdenum alloy powder.

Then, added to the cooled ferromolybdenum alloy powder was 2 wt %, based on the weight of the ferromolybdenum alloy powder, of the wax (Kenolube P11) and they were uniformly mixed together, and then the wax-containing mixture was compacted or pressure-molded at a pressure of 250 bar at room temperature, thereby obtaining a cylindrical molded product having a size of 2 cm (diameter)×2 cm (height). Thereafter, the obtained molded product was heated to 700° C. in a nitrogen atmosphere, and then was hot-sintered at a temperature of 900° C. for 30 minutes in a hydrogen atmosphere. Then, the sintered product was cooled to 550° C. in a hydrogen atmosphere, and then was cooled to 250° C. in a nitrogen atmosphere, thereby manufacturing a sintered ferromolybdenum alloy.

The chemical composition of the sintered ferromolybdenum alloy manufactured in the above Examples 1, 2, and 3 is shown in Table 1 below.

The chemical composition (weight part) of a sintered ferromolybdenum alloy manufactured from a mixed powder of the mill scale (iron oxide) and the molybdenum oxide powder by a solid-gas reaction

TABLE 1

| Classification | Mo | Fe | Cu | Pb | Zn | Al | Ca | Mg | P | Si |
|---|---|---|---|---|---|---|---|---|---|---|
| Example 1 | 51.7 | 45.8 | 0.025 | 0.005 | 0.03 | 0.03 | 0.04 | 0.03 | 0.01 | 0.02 |
| Example 2 | 56.5 | 42.4 | 0.01 | 0.005 | 0.02 | 0.05 | 0.05 | 0.04 | 0.01 | 0.04 |
| Example 3 | 69.6 | 29.5 | 0.01 | 0.005 | 0.04 | 0.05 | 0.05 | 0.04 | 0.01 | 0.04 |

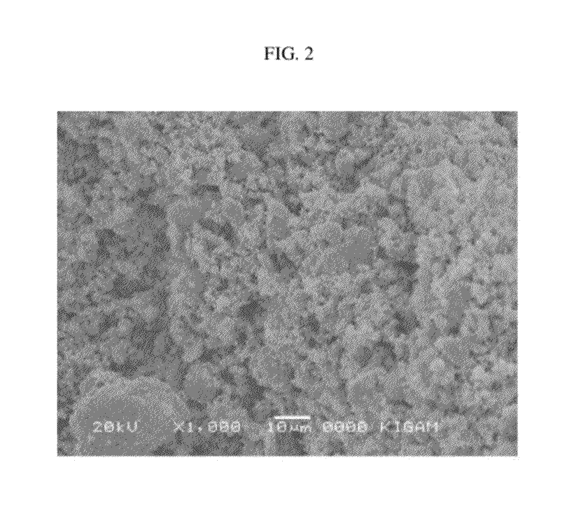

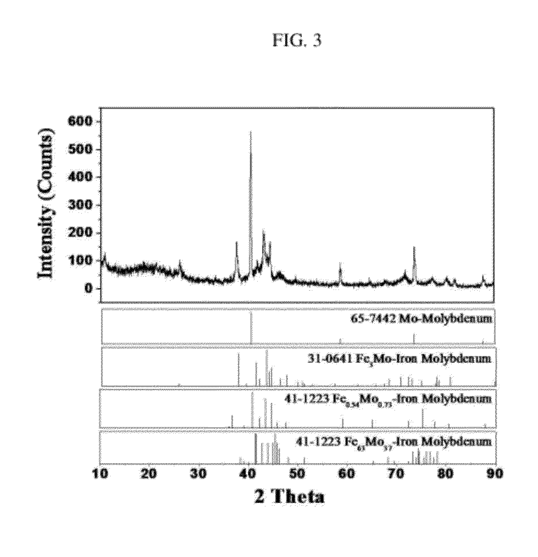

In addition, a photograph taken by an electron microscope of tissues of and a diagram illustrating X-ray diffraction patterns of the ground powders of the sintered ferromolybdenum alloy manufactured in Example 1 are shown in FIGS. 2 and 3, respectively.

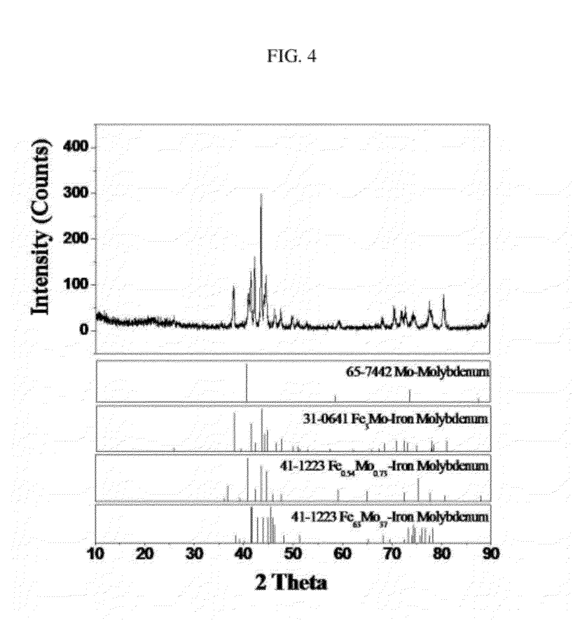

Meanwhile, for the purpose of comparison between the method of the present invention and the conventional method, X-ray diffraction patterns of ground powders of a ferromolybdenum alloy manufactured by a conventional thermite reaction is shown in FIG. 4.

The comparison between X-ray diffraction patterns of FIGS. 3 and 4 shows that there is a slight difference therebetween but their crystalline structures are the same.

### INDUSTRIAL APPLICABILITY

As described above, the present invention provides a method for manufacturing a sintered ferromolybdenum alloy, in which a mixed powder of a mill scale (a mixture of Fe, FeO and Fe₂O₃) discharged from a hot rolling and forging process of the steel-making process and a molybdenum oxide powder is primarily reduced with a hydrogen gas at low temperature, and then is secondarily reduced with the hydrogen gas at high temperature and simultaneously is cooled in a hydrogen atmosphere to thereby obtain a ferromolybdenum alloy in the form of a powder, and subsequently the obtained ferromolybdenum alloy powder is used as a raw material, thereby manufacturing a sintered ferromolybdenum alloy, and a sintered product manufactured by said method. Accordingly, the present invention has several advantageous effects in that the process time is shortened, the necessity of materials such as aluminum, magnesium, ferrosilicon, slag-forming agent, or fire-igniting agent to be introduced separately is removed, and second environment polluting substances are not produced, thereby reducing the investment cost of an environmental pollution preventing facility, thereby saving the manufacturing cost, such that such that the inventive process can be widely used in a manufacturing process of ferroalloys having a high melting point such as ferrovanadium, ferrotitanium, and ferrochrome used for adjustment of components of a molten metal in a steel-making field.

Although the present invention has been described in detail with reference to the specific features, it will be apparent to those skilled in the art that this description is only for a preferred embodiment and does not limit the scope of the present invention. Thus, the substantial scope of the present invention will be defined by the appended claims and equivalents thereof.

1. A method of manufacturing a sintered ferromolybdenum alloy from a mixed powder of a mill scale (a mixture of Fe, FeO and Fe₂O₃) and a molybdenum oxide (MoO₃) powder by a solid-gas reaction, the method comprising the steps of:
(a) grinding a mill scale, which is used as a ferrous raw material, to a particle size of 75-150 μm using a ball mill, while uniformly mixing the mill scale with the molybdenum oxide powder;
(b) partially reducing the mixture resulting from the step (a) with hydrogen at low temperature;
(c) completely reducing the mixture resulting from the step (b) with hydrogen at high temperature;
(d) cooling the mixed alloy resulting from the step (c) in a hydrogen atmosphere to obtain a ferromolybdenum alloy powder;
(e) mixing the ferromolybdenum alloy powder resulting from the step (d) with wax (Kenolube P11) and compacting or pressure-molding the wax-containing mixture;
(f) heating the molded product resulting from the step (e) to 700° C. in a nitrogen atmosphere, and then hot-sintering the molded product at a temperature of 700-900° for 30-100 minutes in a hydrogen atmosphere; and
(g) cooling the sintered product resulting from the step (f) to 550° C. in a hydrogen atmosphere, and then cooling the sintered product to 150-250° C. in a nitrogen atmosphere.

2. The method of claim 1, wherein the ferrous raw material is a mill scale (a mixture of Fe, FeO and Fe₂O₃) having a particle size of 75-150 μm.

3. The method of claim 1, wherein the mill scale (the mixture of Fe, FeO and Fe₂O₃) having a particle size of 75-150 μm is uniformly mixed with the molybdenum oxide powder having a particle size of 75-150 μm.

4. The method of claim 1, wherein the mixture resulting from the step (a) is partially reduced with hydrogen at low temperature.

5. The method of claim 1, wherein the reduction with hydrogen in the step (b) is carried out at 550-600° C. for 30-100 minutes.

6. The method of claim 1, wherein the mixture resulting from the step (b) is completely reduced with hydrogen at high temperature.

7. The method of claim 1, wherein the reduction with hydrogen in the step (c) is carried out at 750-950° C. for 30-100 minutes.

8. The method of claim 1, wherein the mixed alloy resulting from the step (c) is cooled.

9. The method of claim 1, wherein the cooling in the step (d) is carried out by cooling the ferromolybdenum alloy powder to 300-500° C. in a hydrogen atmosphere.

10. The method of claim 1, wherein the ferromolybdenum alloy powder resulting from the step (d) is mixed with the wax (Kenolube P11) and pressure-molded.

11. The method of claim 1, wherein the pressure-molding in the step (e) is carried out by mixing the ferromolybdenum alloy powder resulting from the step (d) uniformly with 2 wt %, based on the weight of the ferromolybdenum alloy powder, of the wax (Kenolube P11), and pressure-molding the wax-containing mixture at a pressure of 250 bar at room temperature, thereby obtaining a cylindrical molded product having a size of 2 cm (diameter)×2 cm (height).

12. The method of claim 1, wherein the molded product resulting from the step (e) is hot-sintered.

13. The method of claim 1, wherein the hot sintering in the step (f) is carried out by heating the molded product resulting from the step (e) to 700° C. in a nitrogen atmosphere, and then heating the molded product to 750-900° C. in a hydrogen atmosphere, followed by hot sintering for 30-100 minutes.

14. The method of claim 1, wherein the sintered product resulting from step (f) is cooled.

15. The method of claim 1, wherein the cooling in the step (g) is carried out by cooling the sintered product resulting from the step (f) to 550° C. in a hydrogen atmosphere, and then cooling the sintered body to 150-250° C. in a nitrogen atmosphere.

16. A sintered ferromolybdenum alloy manufactured according to the method of claim 1.
